(19) United States
(12) Patent Application Publication
(10) Pub. No.: US 2024/0381847 A1
(43) Pub. Date: Nov. 21, 2024

(54) ELECTRONIC TAG

(71) Applicants: MAX-PLANCK-GESELLSCHAFT ZUR FÖRDERUNG DER WISSENSCHAFTEN E.V., Munchen (DE); SOUTH AFRICAN NATIONAL PARKS, Pretoria (ZA); GEPE GEIMUPLAST GMBH, Farchant (DE)

(72) Inventors: Georg HEINE, Wangen im Allgäu (DE); Bernd VORNEWEG, Radolfzell (DE); Martin Christoph WIKELSKI, Konstanz (DE); Ursula Rosa MÜLLER, Konstanz (DE); Jens KOBLITZ, Konstanz (DE); Ockert Louis VAN SCHALKWYK, Skukuza (ZA); Pauli VILJOEN, Skukuza (ZA); Johann SCHÖPF, Garmisch-Partenkirchen (DE); Josef HUTSTEINER, Ohlstadt (DE); Timm WILD, Radolfzell (DE)

(73) Assignees: MAX-PLANCK-GESELLSCHAFT ZUR FÖRDERUNG DER WISSENSCHAFTEN E.V., Munchen (DE); SOUTH AFRICAN NATIONAL PARKS, Pretoria (ZA); GEPE GEIMUPLAST GMBH, Farchant (DE)

(21) Appl. No.: 18/666,238

(22) Filed: May 16, 2024

Related U.S. Application Data
(63) Continuation of application No. PCT/EP2022/082188, filed on Nov. 17, 2022.

(30) Foreign Application Priority Data
Nov. 18, 2021 (EP) 21209118.5

(51) Int. Cl. A01K 29/00; A01K 11/00; A01K 27/00

(52) U.S. Cl. CPC A01K 29/005; A01K 11/004; A01K 11/008; A01K 27/006

(57) ABSTRACT

The present disclosure relates to an electronic tag for behavioural monitoring of animals, the electronic tag comprising a microprocessor and at least one sensor. The electronic tag is configured to obtain, via the at least one sensor, movement data of an animal to which the electronic tag is attached and to determine, based on the obtained movement data, a behaviour of the animal. The disclosure further encompasses a corresponding method as well as an ear tag.

### CROSS-REFERENCE TO RELATED PATENT APPLICATIONS

This application is a Continuation of PCT Application No. PCT/EP2022/082188, filed Nov. 17, 2022, which is incorporated herein by reference in its entirety.

### TECHNICAL FIELD

The present disclosure relates to an electronic tag. More particularly, the present disclosure relates to an electronic wearable tag for remotely monitoring a behavioural state of animals such as wildlife and livestock.

### BACKGROUND

The health monitoring of wildlife and livestock is of increasing need in today's societies around the world. Currently available ear tags for domestic livestock and wildlife are generally large flaps with numbers or electronic units that are heavy (>60 gr) and hang down from the ear tag punch hole. This enables the animal to spin tag and ear flap around, thus damaging the positioning in the ear. Solutions integrated in the pin of an ear tag generally are not able to provide sophisticated data or analysis due to the limited amount of space in the pin. Electronic observation units on mammals are situated around necklaces or collars and most units are battery-powered only. Only very few electronic units record behavioural or physiological parameters.

### SUMMARY

There is thus a need for an electronic tag that resolves the above-mentioned issues. In particular, the present solution may provide a centrally sitting (i.e., non-swinging), very small, solar-powered electronic ear tag that records position and sensor information from IMU sensors (e.g., 3-D acceleration, 3-D magnetometry), interprets the behaviour and health on board and transmits this information through either terrestrial or Ground-to-Satellite IoT networks in near real time. The advantage of this system over others is that it allows for customised, individualised observations of free-roaming animals around the globe in near real time.

The solution is defined the independent claims. Dependent claims describe preferred/some embodiments.

The present disclosure relates to an electronic tag for behavioural monitoring of animals, the electronic tag comprising a microprocessor and at least one sensor. The electronic tag is configured to obtain, via the at least one sensor, movement data of an animal to which the electronic tag is attached and to determine, based on the obtained movement data, a behaviour of the animal.

Various embodiments may implement the following features.

The microprocessor may be configured to determine the behaviour according to at least one behavioural threshold, wherein preferably or in some embodiments the at least one behavioural threshold is individually set for each animal.

The behaviour may comprise at least one of a calm or normal state, an agitated or stressed state and immobility.

Preferably or in some embodiments, the electronic tag further comprises a transmitter or transceiver configured to transmit the behaviour of the animal, wherein preferably or in some embodiments the transmitter or transceiver is configured to perform at least one of internet of things, IoT, communication, GSM, satellite communication, LoRa, SigFox or 5G.

Preferably or in some embodiments, the at least one sensor is at least one of a GPS sensor, an acceleration sensor, a gyroscope, an inertial measurement unit, IMU, a temperature sensor, a humidity sensor, an air quality sensor, an audio sensor, a pressure sensor or a physiological sensor.

Preferably or in some embodiments, the electronic tag further comprises at least one photosensitive element configured to provide energy to an energy storage comprised in the electronic tag.

Preferably or in some embodiments, the electronic tag is removably attached to a collar or a harness, or the electronic tag is removably attached to an ear tag. Preferably or in some embodiments, the electronic tag is positioned centrally with respect to a pin of the ear tag.

The present disclosure further relates to a method for behavioural monitoring of animals, the method being carried out in an electronic tag. The method comprises obtaining, by at least one sensor of the electronic tag, movement data of an animal, processing, by a microprocessor of the electronic tag, the movement data and determining, by the microprocessor, a behaviour of the animal from the movement data.

Various embodiments may implement the following features.

The microprocessor may be configured to determine the behaviour according to at least one behavioural threshold, wherein preferably or in some embodiments the at least one behavioural threshold is individually set for each animal.

Preferably or in some embodiments, the behaviour comprises at least one of a calm or normal state, an agitated or stressed state and immobility.

Preferably or in some embodiments, the movement data comprises at least one of GPS data, acceleration data, gyroscope data or inertial measurement unit, IMU, data, and/or the method further comprises obtaining at least one of temperature data, humidity data audio data, pressure data, air quality data or physiological data of the animal.

Preferably or in some embodiments, the method further comprises transmitting the determined behaviour to a receiving station.

The present disclosure also relates to an ear tag for attachment to an animal's ear and for receiving an electronic tag, preferably or in some embodiments as described above, comprising a pin connected to the ear tag for piercing an animal's ear and a reception space for receiving the electronic tag. The electronic tag, when attached to the ear tag, is positioned centrally with respect to the pin.

Preferably or in some embodiments, the reception space is a slide-in drawer-type reception space configured to detachably receive the electronic tag.

The present disclosure further relates to an ear tag for attachment to an animal's ear and for receiving an electronic tag, preferably or in some embodiments as described above. The ear tag comprises a pin connected to the ear tag for piercing an animal's ear, a reception space connected to the pin, wherein the reception space is positioned centrally with respect to the pin, and a housing configured to close the reception space.

Preferably or in some embodiments, the centre of gravity of the ear tag is positioned centrally with respect to the pin.

The solution will be further described with reference to the figures.

### BRIEF DESCRIPTION OF THE DRAWINGS

FIG. 1 shows a basic configuration according to an example of the present disclosure,

FIG. 2 shows a configuration according to an example of the present disclosure,

FIG. 3 shows an example flow chart according to the present disclosure,

FIGS. 4 to 6 show example acceleration measurements for various applications,

FIG. 7 shows a top view of an ear tag according to an example of the present disclosure,

FIGS. 8A and 8B show side views of an ear tag according to an example of the present disclosure,

FIGS. 9A and 9B show an example ear tag receiving an electronic tag,

FIGS. 10A and 10B show an example ear tag, and

FIG. 11 shows a cross-sectional view of the assembled ear tag according to FIGS. 10A and 10B.

### DETAILED DESCRIPTION

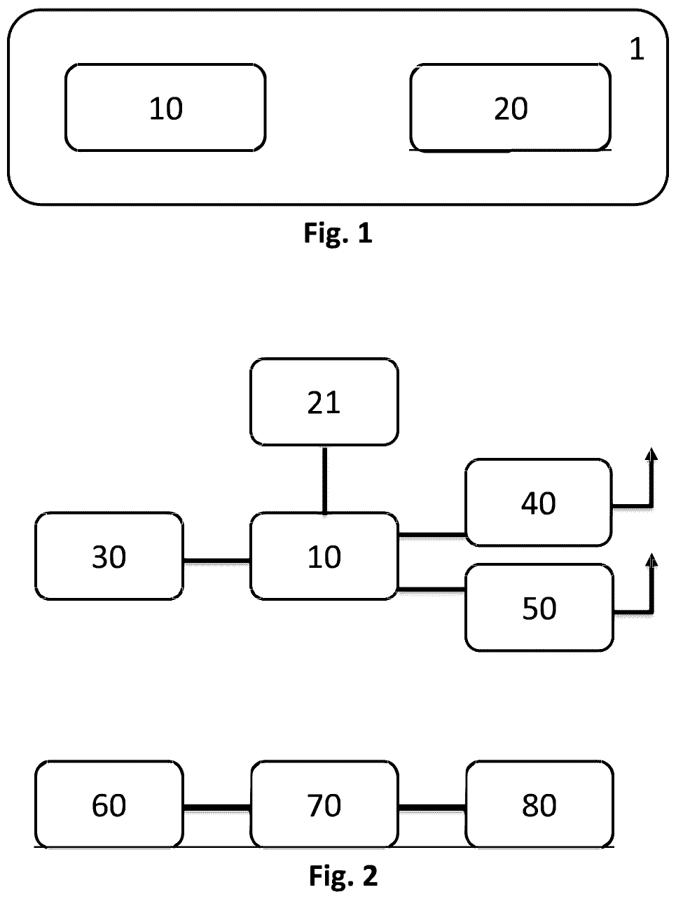

FIG. 1 shows a basic configuration of an electronic tag 1 according to the present disclosure, comprising a microprocessor 10 and at least one sensor 20. The electronic tag 1 is configured to be attached to an animal and to monitor the behaviour of animals such as wildlife or livestock by obtaining, via the at least one sensor 20, movement data of the animal. Based on said movement data, a behaviour of the animal is determined. The behaviour may thereby relate to at least one state of the animal such as a normal state, an agitated or stressed state or immobility, i.e., death. The functionality of the electronic tag 1 will be further described below.

FIG. 2 depicts a further configuration of the electronic tag 1. The electronic tag 1 comprises a microprocessor 10 or central processor unit which is connected to a memory 30 and a sensor 20, in this example a 3-axis acceleration sensor 21. Furthermore, a GPS receiver 40 as well as a communication module 50 as described below are connected to the microprocessor 10. The communication module 50 may be provided as a transmitter or transceiver. The electronic tag also comprises an energy storage 80 such as a lithium polymer accumulator, an energy source 60 such as a photosensitive element and a power management 70 or energy harvester for managing and distributing the energy. The energy storage 80 is at least connected to the microprocessor 10 and may also be connected to the communication module 50 and/or the memory and/or the GPS receiver and/or the sensor(s) 20, 21 (not explicitly shown in the figure).

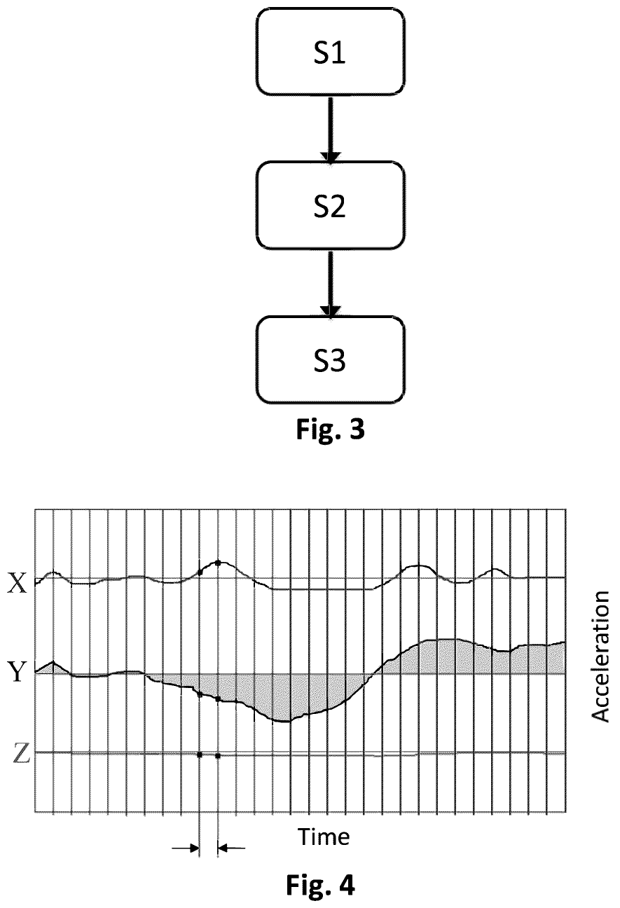

The present disclosure also relates to a corresponding method. An example flow chart is shown in FIG. 3. The method comprises step S1 of obtaining, by at least one sensor 20 of the electronic tag 1, movement data of an animal, step S2 of processing, by a microprocessor 10 of the electronic tag 1, the movement data, and step S3 of determining, by the microprocessor 10, a behaviour of the animal from the movement data.

Determination of the behaviour may be performed according to at least one behavioural threshold. Preferably or in some embodiments the at least one behavioural threshold is individually set for each animal. As indicated above, the behaviour comprises at least one of a calm or normal state, an agitated or stressed state and immobility. As explained above, the movement data may comprise at least one of GPS data, acceleration data, gyroscope data or inertial measurement unit, IMU, data. The method may further comprise obtaining at least one of temperature data, humidity data, audio data, air pressure data, air quality data or physiological data of the animal. The method may also comprise transmitting the gathered data and/or the behavioural data to a receiving station such as a smartphone, a base station, a computer, a server, a satellite or similar.

An electronic tag 1 as disclosed herein may also be referred to as a data logger. It can be particularly used for behavioural monitoring of animals such as wildlife or livestock and comprises a microprocessor 10 and at least one sensor 20. The sensor may be an acceleration sensor 21, e.g., a three-axis acceleration sensor, configured to acquire acceleration data of the electronic tag 1. The data acquired by the acceleration sensor 21 can be used to determine movement data of an animal to which the electronic tag is attached. Furthermore, a GPS sensor or GPS receiver 40 may be provided to provide localisation data in addition to the acceleration sensor 21 or taken alone. Thereby, the position of the animal may also be acquired.

The microprocessor 10 is configured to determine a behaviour of the animal to which the electronic tag 1 is attached based on the data acquired by the sensor 20, 21. In particular, their behaviour may relate to at least one of a normal state, agitated state or stressed state and immobility, i.e., death of the animal. Determination of the respective state performed by setting at least one behavioural threshold. Advantageously, the behavioural threshold is set individually for the respective animal. The sensor 20 may also be at least one of a temperature sensor, a humidity sensor, a gyroscope, an inertial measurement unit (IMU), an audio recorder, air pressure sensor, air quality sensor or physiological sensor to determine physiological data of the animal such as blood flow to determine heart rate, breathing rate, etc. The electronic tag 1 may further comprise a memory 30, e.g., a flash memory, connected to the microprocessor 10.

The electronic tag 1 therefore is able to compute or determine a behavioural state of the animal without the need for external means of processing. Consequently, the need to store and/or transmit raw data on the electronic tag is rendered moot.

Data from the electronic tag 1 may be collected using a wired or wireless connection. Therefore, a communication module 50 may be provided. The communication module 50 may be configured to perform data transmission and/or reception via at least one of Bluetooth, SIGFOX, LoRa WAN, 5G, GSM or lot (Internet of things) communication, in particular narrowband IoT (NB-IoT). Furthermore, ground to space, i.e., satellite communication, communication, such as such as ICARUS communication, may also be used. In other words, the communication module 50 may be provided as a transmitter or transceiver. Thus, the data (raw data and/or behavioural data) may be transmitted to a receiving station such as a smartphone, a base station, a computer, a server, a satellite or similar.

The communication module 50 may be used for online monitoring (data upload) and for controlling the test settings (data download) as well as parameter setting.

The electronic tag 1 may further comprise an energy storage 80 such as a battery or an accumulator. The energy storage may be provided in the form of a lithium polymer cell. In addition, an energy source 60 such as a photosensitive element (e.g., a solar cell), may be provided to provide energy to the energy storage 80. The energy storage 80 is configured to power the microprocessor 10 as well as the at least one sensor 20, 21, the GPS sensor 40 and the communication module 50. In order to manage and distribute energy, an energy harvester or power management 70 may be provided and connected to the energy storage 80 and/or the energy source 60.

In the following, an example of the operation of the acceleration sensor and the data processing of the electronic tag is given. The parameters and numbers are not to be seen as restricting the scope of the present disclosure.

The acceleration sensor 21 is put into operation cyclically and supplies a measured value for the X, Y and Z axes for each measurement. The measuring frequency (standard 16 Hz) and measuring duration are adjustable. The recorded values of a measuring cycle are evaluated according to various criteria in the central processor unit, i.e., the microprocessor 10.

Since a data logger such as the electronic tag 1 and thus the acceleration sensor 21 cannot be attached to an animal with a fixed orientation, the differences to the mean values of the 3 axes are used to obtain information about the condition and behaviour of the animals. Trigger thresholds can thus be used to obtain information on the behaviour and condition of an animal. Different animal species require different trigger thresholds which require different individual settings even within one species. The settings can be made individually via a download of defined commands.

A data message of, according to the present example, 12 bytes contains the geographical coordinates, timestamp, battery voltage and the memory index under which the data record is stored in the memory 30 of the electronic tag 1. There may also be status and alarm messages. With the help of the memory index, it is possible to subsequently read out data that was not transmitted, e.g., due to a missing radio connection.

In FIG. 4, example acceleration measurements of the X, Y and Z axes over time are shown. The horizontal lines indicate the mean values of the acceleration in the X, Y and Z direction, respectively. The vertical lines indicate the measurement intervals, in the present example 1 second. The acceleration measurements were performed with a BMA 280 sensor by Bosch. The sensor generates acceleration measurement values of 3 axes (X,Y,Z) with a resolution of 14 bit each (16384 1sb). The sensor is initialised to the highest sensitivity of +−2 g by default.

The measurements are carried out cyclically in the ACC measuring cycle. This clock is variable, is preset to 10 sec and can be changed by cable, i.e., through a wired connection, as well as by a download command, e.g., via a wireless connection. Basic clock is 1 sec. The measured values are written separately as X, Y,Z into a buffer which also has a variable length. The maximum buffer length is 256, preset is 128 measurement values for each Y,X and Z. When the buffer is full (memory pointer=NSP), the program starts again at memory location 1 and overwrites the old measured values. It is advantageous to use a binary number (e.g., 256, 128, 64, 32) for the memory length because the computational effort in the processor is then smaller—instead of a division a simple shift-right instruction can be used.

The memory length together with the measuring clock determine the temporal behaviour of the algorithm. With the standard settings (10 sec measuring cycle, n=128 measurements) an inertia of 1280 sec=21.3 minutes results. It therefore takes at least 1× inertia or a maximum of 2× inertia for the algorithm to respond.

The calculation process to determine whether an animal is immobile or dead, i.e. the behavioural status, can in principle be executed at any time. By default, the calculation process is executed in the cycle of the inertia (preset every 21.3 minutes).

Calculation of the mean values Xₘₑₐₙ of the X axis is shown below, wherein NSP denotes the memory length and n denotes the memory position and X_accₙ the acceleration value at memory position n.

$${X}_{m e a n} = \frac{{\sum }_{n = 1}^{N S P} {X\_acc}_{n}}{N S P}$$

The same computation can be performed for the Y and Z axes.

With the next calculation step, the sum of the deviations from the mean value is formed separately for each axis. The amounts of the deviations are summed up and a mean deviation is calculated by dividing by NSP.

$${X}_{death} = \frac{{\sum }_{n = 1}^{NSP} \vert {X\_acc}_{n} - {X}_{m e a n} \vert}{N S P}$$

The final acceleration value is yielded by addition of the values of each axis, i.e.

$${CC}_{death} = {X}_{death} + {Y}_{death} + {Z}_{death} .$$

The value “ACC_death” determined in this way is finally compared with a threshold value (death_level). If the calculated value ACC_death is smaller than the threshold value death_level, the animal is dead. Death_level can be set via a download command which allows an individual adjustment.

The electronic tags or loggers will/can first lie still for some time in a test mode and would then constantly send an alarm message. To prevent this, it is necessary to set up an on/off option. By default, the ACC sensor is set to OFF and only switched on e.g., via download command when the electronic tag or logger is at the animal.

Furthermore, the electronic tag 1 may comprise an action algorithm, i.e., a determination of the behavioural state of the animal to which the electronic tag 1 is attached. The determination and computation, respectively can advantageously be performed by the microprocessor and thus directly on the electronic tag 1.

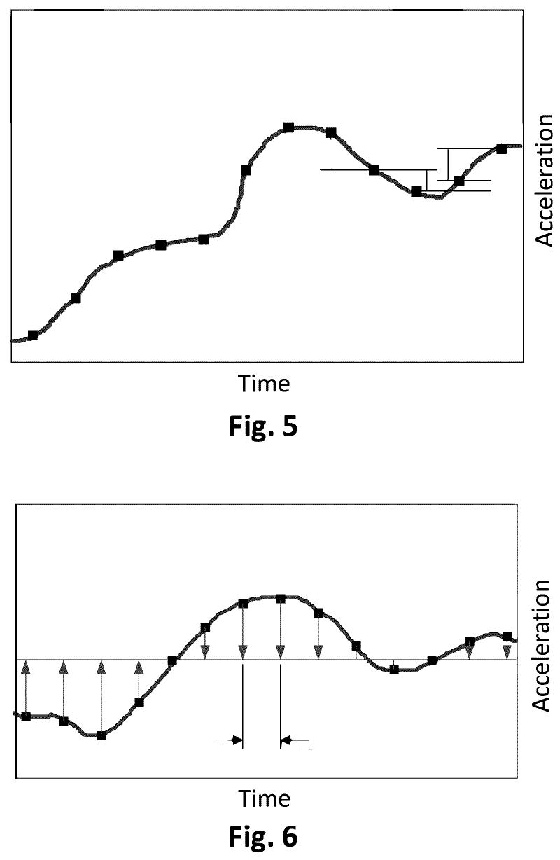

The Action Algorithm is used to determine when an animal is excessively active. For example, it is expected that particularly large or rapid acceleration changes occur when animals are on the run. An example measurement of the activity, i.e., the acceleration data, over time is shown in FIG. 5. Again, the x axis indicates the time while the y axis indicates the acceleration values. Each measurement value is shown by a small square. The horizontal and vertical lines indicate the differential values, i.e., the differences between the measurement values.

The determination of the behavioural state may be based on the same measurements that are recorded in the death algorithm presented above. Thus, there is a memory area which contains the ACC-measurements for the three axes X_accₙ, Y_accₙ and Z_accₙ. Starting from the current measured value act_N, the amount of difference is added to the previous measured value. The number how many measured values come into the calculation is determined by the variable N_action. The calculation is carried out in each case separately for all three axes.

$${X}_{action} = \frac{{\sum }_{n = act \_ N}^{{act}_{N} - N \_ action} \vert {X\_acc}_{n} - {X\_acc}_{n - 1} \vert}{N\_action}$$

The index for the memory access thus runs backwards.

For the evaluation whether an unusual activity is present, there is a threshold value Action_Level which triggers an alarm message if the threshold is exceeded. The value of Action_Level is adjustable via a download command and can thus be adapted individually.

The electronic tag 1 and the respective measurements and processing can also be used for earthquake detection. Therefore, the behaviour of animals, e.g., cows, is monitored and evaluated.

The algorithm in which restlessness or agitation is measured on cattle is based on a cyclic measurement period of e.g., 20 sec. The measurement is performed with a sampling frequency of 16 Hz. This cyclic measurement is repeated every 3 minutes. For cattle, the measurement cycle of 3 minutes was chosen because of the battery capacity and the runtime of about 6 months. For tags on ear tags, the measurement period could be set to a few seconds and the cycle time to a value greater than a few minutes.

Cyclically, e.g., every 5 minutes a measuring period of e.g. 5 sec is started during which data (X, Y,Z) is stored with a sampling frequency of e.g. 16 Hz. With this measuring method, the actual movement is measured due to the high measuring frequency. In the end it is the change of the acceleration due to gravity on the 3 axes. The calculation of the unsteadiness is done via the difference amounts to the mean value.

An example measurement is shown in FIG. 6, in which the deviation from the mean value (the straight line in the middle) over time is depicted. The mean value is indicated by the horizontal line, each measurement point is indicated by a small square. The vertical lines show the deviation from the mean value and are spaced from each other by the sample interval.

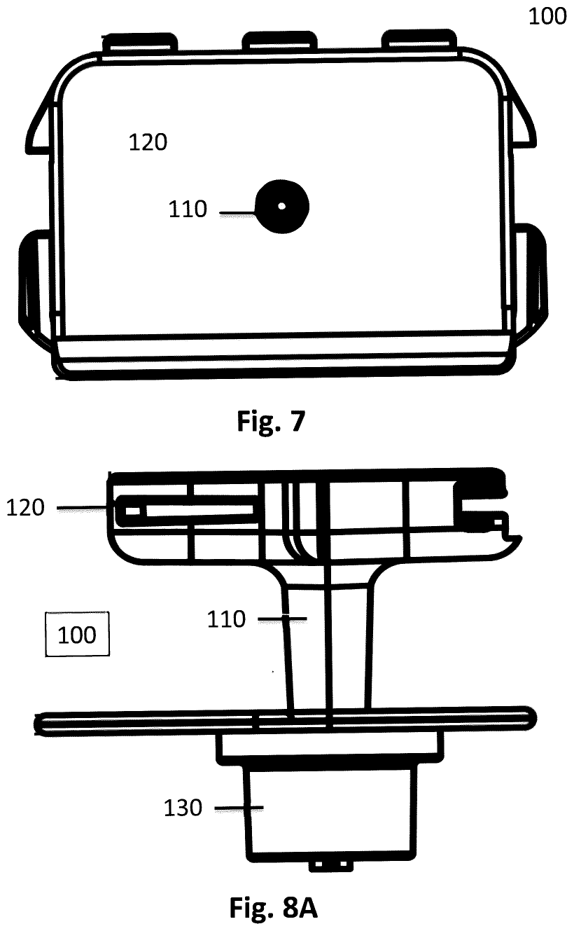

The present solution further relates to an ear tag 100 for attachment to an animal's ear. The ear tag 100 may also receive an electronic tag 1 as described above. FIG. 7 shows a top view of an example ear tag 100. The ear tag 100 may comprise a reception space 120 for receiving the electronic tag 1. The reception space 120 can e.g., be a slide-in drawer type reception space. In this manner, the electronic tag 1 may easily be attached and detached to the animal's ear while always ensuring correct positioning during use. In FIGS. 7 to 9, a substantially rectangular drawer-type reception space 120 is shown which comprises two shorter and two longer sides, wherein one of the longer sides is open for receiving the electronic tag 1. The reception space 120 may comprise means for securing the electronic tag 1 in place such as a snap-in connection, click connection, friction connection or similar. Other shapes and reception types may be feasible.

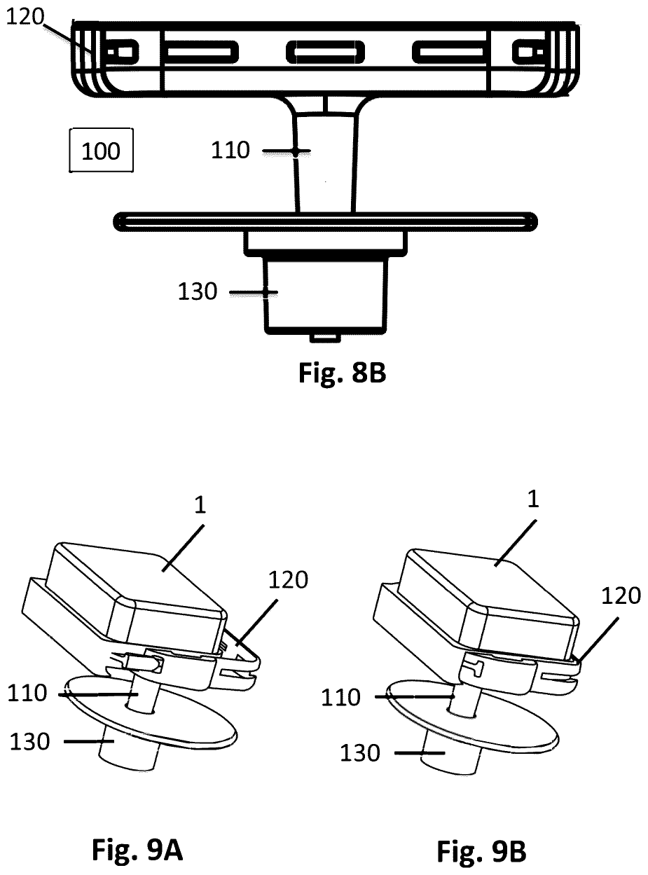

FIGS. 8A shows a side view of a shorter side of an ear tag 100 according to an example and FIG. 8B shows a side view of a longer side of an ear tag 100 according to the example. The views of FIGS. 8A and 8B are thus tilted 90° with respect to each other. As shown in the figures, the ear tag 100 comprises a pin 110 connected to the ear tag 100 for piercing an animal's ear. The pin 110 may be integrally formed with the reception space 120 or may be attached via a glued connection, a screw connection or other attachment means. Moreover, a holding piece 130 which is in engagement with the pin 110 is provided in order to secure the ear tag 100 when the pin 110 is pierced through an animal's ear. The holding piece 130 thus acts as a counter piece to the reception space 120. The shape of the holding piece 130 as shown in the figures is not to be seen as restrictive and other shapes or means of attachment may be feasible. Moreover, an ear tag 100 without a holding piece 130 may also be employed according to the disclosure, e.g., by providing a self-securing pin 110.

The electronic tag 1, when attached to the ear tag 100, is positioned centrally with respect to the pin 110 as also evident from the figures. Thereby, no free-swinging or pendulum effect occurs which might distort the acceleration measurements.

FIGS. 9A and 9B show the process of inserting an electronic tag 1 according to an example as described above into an ear tag 100 according to an example as described above.

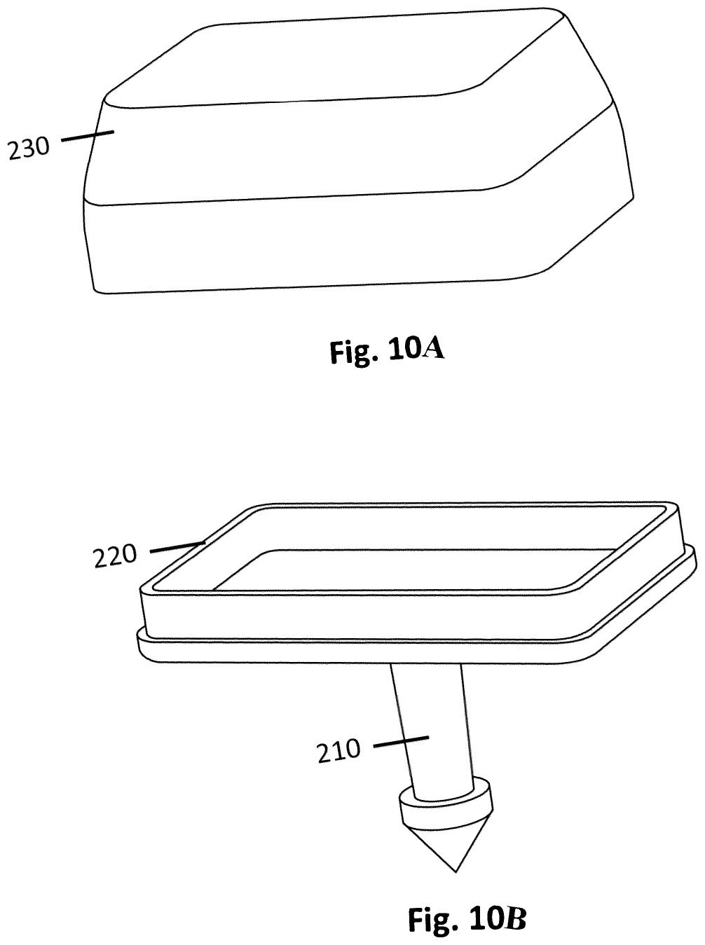

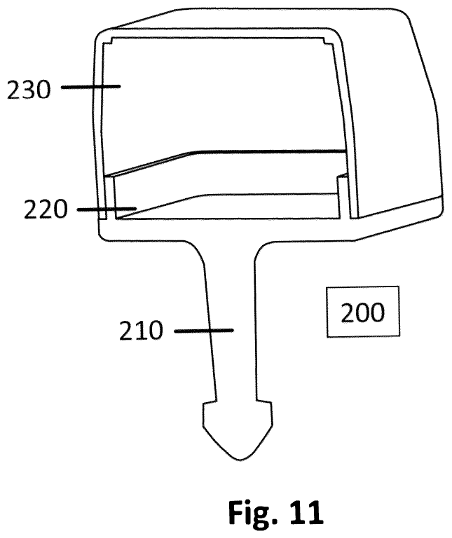

FIGS. 10 to 11 show a further example embodiment of the present disclosure. This example also relates to a compact, lightweight ear tag 200 for use with an electronic tag, wherein the centre of gravity is positioned centrally with respect to the pin.

The ear tag 200 according to FIGS. 10A and 10B comprises a pin 210, a reception space 220 and a housing 230 configured to close the reception space 220. Inside the reception space 220, an electronic tag 1 as described above may be positioned.

The reception space 220 is connected to the pin 210. Both elements may be integrally formed or connected by a suitable means of connection such as glue, clip-on, screw, or similar.

The reception space 220 is aligned centrally with respect to the pin 210 such that the centre of gravity sits above the pin 210. Particularly, also when the electronic tag 1 is positioned in the reception space 220, the centre of gravity may be above the pin 210. Thereby, swinging effects or pendulum effects can be avoided. The ear tag 200 may be fixed to an ear of an animal by a holding piece (not shown, may be similar as depicted in FIGS. 8 to 9).

The reception space 220 may be essentially rectangular. However, a round shape or any other, particularly symmetric, shape may also be used. A central axis of the pin 210 may form a symmetrical axis of the ear tag 200.

In an example, the reception space 220 comprises a wall which is recessed from the outer circumference of the reception space 220. The housing 230 may close the reception space 220 by friction between an inner wall of the housing 230 and the wall of the reception space 220. Also, a clip-on connection, a glued connection, screw connection or any suitable means of connection may be employed to (removably) fix the housing 230 to the reception space 220. The connection may particularly serve to enclose the reception space 220 and the electronic tag 1 positioned therein to protect the electronic tag 1 from environmental influences such as water. However, depending on the type of sensors used in the electronic tag 1, a full hermetic enclosure may not be necessary or even hindering, e.g., if humidity, pressure, temperature etc. of the animal's environment shall be monitored. A solar cell or other photosensitive element may be used as a power source and positioned on an outside of the housing 230.

FIG. 11 shows a sectional view of an assembled ear tag 200 according to FIGS. 10A and 10B through the centre of the pin 210. The electronic tag 1 is not shown in this example.

In summary, the advantages of the electronic tag and in particular the electronic tag in combination with the ear tag are as follows.

The ear tag's pin sits centrally, so no free-swinging/pendulum effect of the ear tag is possible. This is achieved by the use of a slide-in drawer-type reception system implemented in the ear tag. This drawer receives the electronic tag base and provides a strong and tight link between the ear tag and the electronic tag. Alternatively, the ear tag may be designed without the slide-in drawer and thus with compact dimensions and a simpler construction. By positioning the centre of gravity centrally above the pin, a swinging or pendulum effect can be avoided and hence, injuries to the animal's ear or discomfort may be reduced.

The electronic tag is solar powered and very small, below 30 gr or below 20 gr, preferably or in some embodiments below 15 gr in different combinations, and features a solar panel that allows for the constant recharge and very long life of the electronic tag. By employing an intelligent power management, size, weight and complexity of the electronic tag may be reduced. Furthermore, by having simpler requirements on the electronic components due to the reduced complexity and power consumption, the electronic tag, also in combination with the ear tag when positioned therein, provides a lightweight, effective and precise device for monitoring the behaviour of animals.

The electronic tag records GPS location, but also IMU sensor information plus other sensors for temperature, humidity, etc. Uniquely, the electronic tag then uses internal calculation power to analyse the sensor data collected from the animal to create intelligent output parameters in a much lower dimension, e.g., 3-D acceleration data are reduced to stress levels of the animal or to energy expenditures. These data are then also related to health and well-being of the animal or, alternatively, immediately indicate the distress of an animal. Death is recorded primarily by 3-D acceleration that is measured as flat line below sensor noise for a specific period of time, e.g., 10 minutes.

The electronic tag can also be used independently of the ear tag on collars or harnesses in species where ear tagging is not desirable. Very importantly, the sensor information and the internal calculation are not done on a population level, i.e. the same algorithms are used for all individuals, but instead the sensor information of each individual is adjusted to its behaviour.

For example, the same amount of 3-D acceleration in one individual of one species may not yet indicate stress and discomfort, but in another individual with much lower threshold it may already indicate strongly stressful conditions. The on-board interpreted information of the sensor data is subsequently being used either as threshold information or through artificially intelligent algorithms to trigger an immediate message through the communication networks. For example, if the death indicator determines the demise of the animal, or if the stress indicator determines highly stressful conditions, messages are sent immediately to the animal managers via communication networks.

The electronic tag uses a combination or single sources of communication channels, particularly the IoT (Internet of Things) networks, such as NB-IoT (Narrowband IoT), SigFox, LoRaWAN or Ground-to-Satellite IoT, such as ICARUS communication schemes.

Typical use cases of these ear tagging systems are the study of the ontogeny of animals, i.e., the tagging of young mammals and continued observation throughout the lifetime of an animal. Each ear can receive an ear tag and therefore the transmissions from different ears can occur at different times, in effect doubling the transmission numbers based on solar power plus having failure redundancy.

The tags function like wearables for wildlife, i.e., they determine the behaviour and health status of individuals wherever they roam. The combination of GPS and IMU also enables high-definition dead reckoning to decrease the energy expenditure necessary for GPS. Moreover, the combination of different IoT protocols enables communication from anywhere in the world, but also rapid near real-time communication with managing entities. The monitored animals can either be livestock, wildlife game, farm animals or true wildlife. The small size and weight of the tags enables tagging of all mammals above 1 kg.

Other aspects, features, and advantages will be apparent from the summary above, as well as from the description that follows, including the figures and the claims.

While the invention has been illustrated and described in detail in the drawings and foregoing description, such illustration and description are to be considered illustrative and not restrictive. It will be understood that changes and modifications may be made by those of ordinary skill within the scope of the following claims. In particular, the present invention covers further embodiments with any combination of features from different embodiments described above and below.

Furthermore, in the claims the word “comprising” does not exclude other elements or steps, and the indefinite article “a” or “an” does not exclude a plurality. A single unit may fulfil the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.
1 Electronic tag
10 Microprocessor
20 Sensor
21 Acceleration sensor
30 Memory
40 GPS receiver
50 Communication module
60 Energy source, photosensitive element, solar cell
70 Energy harvester, power management
80 Energy storage
100 Ear tag
110 Pin
120 Reception space
130 Holding piece
200 Ear tag
210 Pin
220 Reception space
230 Housing

1. Electronic tag for behavioural monitoring of animals, the electronic tag comprising:
a microprocessor, and at least one sensor,
wherein the electronic tag is configured to obtain, via the at least one sensor, movement data of an animal to which the electronic tag is attached,
wherein the microprocessor is configured to determine, based on the obtained movement data, a behaviour of the animal.

2. The electronic tag according to claim 1, wherein the microprocessor is configured to determine the behaviour according to at least one behavioural threshold,
wherein the at least one behavioural threshold is individually set for each animal.

3. The electronic tag according to claim 1, wherein the behaviour comprises at least one of a calm or normal state, an agitated or stressed state, or immobility.

4. The electronic tag according to claim 1, further comprising a transmitter or transceiver configured to transmit the behaviour of the animal,
wherein the transmitter or transceiver is configured to perform at least one of internet of things (IoT) communication, global system for mobile communication (GSM) communication, satellite communication, long range (LoRa) communication, SigFox communication or 5G communication.

5. The electronic tag according to claim 1, wherein the at least one sensor is at least one of a global positioning system (GPS) sensor, an acceleration sensor, a gyroscope, an inertial measurement unit (IMU), a temperature sensor, a humidity sensor, an air quality sensor, an audio sensor, a pressure sensor or a physiological sensor.

6. The electronic tag according to claim 1, further comprising at least one photosensitive element configured to provide energy to an energy storage comprised in the electronic tag.

7. The electronic tag according to claim 1, wherein the electronic tag is removably attached to a collar or a harness, or
wherein the electronic tag is removably attached to an ear tag, and wherein the electronic tag is positioned centrally with respect to a pin of the ear tag.

8. A method for behavioural monitoring of animals, the method being carried out in an electronic tag comprising:
obtaining, by at least one sensor of the electronic tag, movement data of an animal,
processing, by a microprocessor of the electronic tag, the movement data, and
determining, by the microprocessor, a behaviour of the animal from the movement data.

9. The method according to claim 8, wherein the microprocessor is configured to determine the behaviour is performed according to at least one behavioural threshold,
wherein the at least one behavioural threshold is individually set for each animal.

10. The method according to claim 8, wherein the behaviour comprises at least one of a calm or normal state, an agitated or stressed state, or immobility.

11. The method according to claim 8, wherein at least one of:
the movement data comprises at least one of global positioning system (GPS) data, acceleration data, gyroscope data or inertial measurement unit (IMU) data, or
the method further comprises obtaining at least one of temperature data, humidity data, audio data, pressure data, air quality data or physiological data of the animal.

12. The method according to claim 8, further comprising transmitting the determined behaviour to a receiving station.

13. The electronic tag according to claim 1, wherein the electronic tag is for attachment to an ear tag comprising:
a pin connected to the ear tag for piercing an animal's ear;
a reception space connected to the pin, wherein the reception space is positioned centrally with respect to the pin, and
a housing configured to close the reception space.

14. The electronic tag according to claim 13, wherein the centre of gravity of the ear tag is positioned centrally with respect to the pin.
